(19) United States
(12) Patent Application Publication
(10) Pub. No.: US 2021/0384807 A1
(43) Pub. Date: Dec. 9, 2021

(54) MINIATURE STEP MOTOR WITH INDEPENDENT PHASE STATORS

(71) Applicant: Lin Engineering, Inc., Morgan Hill, CA (US)

(72) Inventor: Ted T. Lin, Saratoga, CA (US)

(73) Assignee: Lin Engineering, Inc., Morgan Hill, CA (US)

(21) Appl. No.: 17/010,140

(22) Filed: Sep. 2, 2020

Related U.S. Application Data
(60) Provisional application No. 63/033,997, filed on Jun. 3, 2020.

(51) Int. Cl. H02K 19/10; H02K 37/14; H02K 15/06

(52) U.S. Cl. CPC H02K 19/10; H02K 15/02; H02K 15/062; H02K 37/14

(57) ABSTRACT

A miniature step motor is constructed with a permanent magnet rotor and a hybrid stator assembly. The rotor, mounted for rotation on an axial shaft, has one or more rotor sections or pieces with a pair of magnetic poles on opposed circumferential surfaces of each piece. The stator assembly, with an inner diameter to receive the rotor, is formed from a stack of bipolar phase-stators positioned in different axial planes, each phase-stator interacting with a rotor section via a two-dimensional magnetic flux path that is independent of every other phase-stator in the stack. The at least one rotor section and the phase-stators have different amounts of rotor-stator rotational offsets at specified angles 180°/N relative to each other about the axial shaft, where N is the number of motor phases. The phase-stators can be mutually offset from one another, or the rotor sections can be mutually offset.

### CROSS-REFERENCE TO RELATED APPLICATION

This application claims priority under 35 U.S.C. 119(e) from prior U.S. provisional application No. 63/033,997, filed Jun. 3, 2020.

### TECHNICAL FIELD

This invention relates to step motors, that is, electric motor structures designed to rotate step-by-step between established electromagnetic detent positions and specially to step motors having permanent magnet (PM) type rotors and hybrid type stators. More particularly, the invention relates to step motors having design features that permit manufacture of ever smaller motors, with special attention to the demand for low noise, increased motor speeds, high/low speed control, and higher torque.

### BACKGROUND ART

Demand for smaller motors is high for a number of applications, such as medical and laboratory equipment (e.g. centrifuges), as well as many positioning and speed control devices used in motion control (e.g. pumps, fans, printers and copiers, and even window drapery open/close control units). Low or reduced noise is also required in many of these applications. Some applications further require high motor speeds, with speed control ability and adequate torque from such motors.

The permanent magnet (PM) rotor has been used in 3-phase steppers, brushless DC motors, and 2-phase low-resolution can-stack PM steppers. In the can-stack type of design, bonded 75% Neodymium-Iron-Boron magnetic material has been commonly used for its permanent magnet rotor. Because most of the applications require low speed and low torque at low cost, 2 phase can-stack miniature steppers are generally designed with 18° per full step. The rotor must have 5 pole-pair magnets. The magnet pole strips become very narrow when the rotor's outer diameter (OD) is small and cannot produce enough magnetic flux to generate a significant torque. Thus, the demand for higher torque cannot be fulfilled by a standard can-stack PM stepper.

Hybrid step motors are designed for high step resolution and high step accuracy applications and are widely used in many precision positioning devices. These typically operate at low speed.

Using a permanent magnet (PM) type rotor with a hybrid stator cannot produce enough torque in most cases due to limitations upon the rotor's magnetic pole width. A popular two-phase 1.8° stepper requires 100 magnetic poles (50 N & 50 S) on the rotor. With a typical rotor diameter of about 25 mm, the magnet-pole width (not counting the gap between poles) for the 100-pole rotor would be around (25 mm×π/100). 0.785 mm. This narrow width cannot produce enough magnetic strength from the permanent magnet rotor.

### SUMMARY DISCLOSURE

The invention assembles 4 sets of coils with independent flux paths to make a manufacturable miniature stepper with highly efficient design. Specifically, a new 2-phase bipolar step motor combines two sets of coils to become one phase-stator. Another phase-stator of like construction is stacked with a rotor-stator relative axial rotational shift to complete the stator assembly. In a preferred 2-phase motor, the pair of phase-stators are axially rotated 90° relative to each other. Alternatively, two stacked rotor sections can be rotated by 90° relative to each other while the pair of phase-stators are axially aligned. In 3-phase (and 5-phase) step motors it is preferred that the three (or five) phase-stators are all aligned while corresponding rotor sections are axially rotated 60° (or 36°) relative to each other.

A step motor in accord with the present invention includes a permanent magnet (PM) rotor and a hybrid stator assembly. The PM rotor is mounted for rotation on an axial shaft. The rotor has at least one axial section, where each section has a pair of magnetic poles on opposed circumferential surfaces. The rotor fits within an inner diameter of the hybrid stator assembly separated by a small radial gap (typically of about 0.1 mm). The hybrid stator assembly is formed of a set of bipolar phase-stators, usually one for each motor phase, that are arranged along an axial direction. Each phase-stator has its own independent two-dimensional flux path with no axial component) that interacts with the PM rotor poles to cause the rotor to rotate. Additionally, the at least one rotor section and the phase-stators have different amounts of rotor-stator rotational offsets at specified angles 180°/N, where N is the number of motor phases.

The relative rotor-stator offsets can be made either by offsetting the different phase-stators or by offsetting multiple rotor sections. Thus, in one embodiment there may be a single axial section of the rotor and the different phase-stators are rotationally offset by the specified angles 180°/N relative to each other about the axial shaft. For example, in a two-phase motor (N=2), a phase-stator A can be rotationally offset by 90° from ae phase-stator B. Alternatively, in another embodiment there may be N rotor sections, one for each motor phase, that are rotationally offset by the specified angles 180°/N relative to each other about the axial shaft, while the different phase-stators are all rotationally aligned. For example, in a three-phase motor (N=3), three phase-stators A, B and C may be aligned but with three corresponding rotor sections mutually offset from each other by 60°.

Each phase-stator further comprises a pair of C-shaped sub-stators with a thin arcuate middle strip portion wound with conductive wire coils and two outer end portions that form the two stator poles. The sub-stators may have registration features that receive alignment pins that hold the resulting phase-stators together with the proper mutual offsets.

One method of forming a step motor may begin by stacking a set of sheet laminations of soft ferromagnetic material to form at least four identical sub-stators, each sub stator having a thin middle strip and two outer end portions. Next, the thin middle strip of each sub-stator is wound with conductive wires to form electromagnetic coils that when energized form stator poles in the two outer end portions. Pairs of sub-stator are assembled to form at least two phase-stators, the sub-stators mating with each other at their two outer end portions in interlocking joints. The phase-stators are stacked to form a stator assembly. Different phase-stators A and B in the stack are kept oriented at 90° relative to each other about a central axis by means of registration features, that can include a set of alignment pins. A permanent magnet rotor is mounted for rotation on an axial shaft within the stator assembly, the rotor having at least one pair of magnetic poles formed by rare-earth magnet material arranged axially on the rotor with alternating north and south magnetic polarity around a circumference of the rotor. Each phase-stator interacts with a rotor via a two-dimensional magnetic flux path that is independent of the other phase-stators in the stack, wherein successive energization steps of phases A+, B+, A−, and B− of the stator assembly drive stepping of the rotor between successive detent positions.

The invention is preferably designed for a. 90° stepper. Using a permanent magnet rotor having one pole-pair of magnets—one North pole & one South pole—ensures that the magnets are wide enough to generate a usable magnetic flux in a small diameter (such as 3 or 4 mm) rotor.

To produce a usable torque, every miniature motor is accompanied by a small speed reducer (gearbox). The resolution of the stepper is no longer important. Instead, the higher speed become more important. The invention has 90° per full step motor to achieve higher speed than finer resolution (e.g. 18°) steppers with the same pulse rates.

The invention is aiming for an overall motor size that is smaller than 13 mm in diameter. The novel design can apply to miniature step motors with overall sizes from 10 mm to 4 mm. Corresponding rotor diameters are smaller than 6½ mm, and about 2 mm for the smallest step motors.

### BRIEF DESCRIPTION OF THE DRAWINGS

FIG. 1 is a perspective view, FIG. 2 is an axial section view, and FIG. 3 is lengthwise cutaway view of an embodiment of a two-phase bipolar step motor in accord with the present invention.

FIG. 4A is a perspective view, FIG. 4B is an end view and FIG. 4C is an axial section view of a rotor for the step motor of FIGS. 1-3. The rotor fits within the inner diameter of the stator assembly of the motor.

FIG. 5 is a perspective view, FIG. 6 is a side view, and FIG. 7 is an end view of a stator assembly core without windings for the step motor of FIGS. 1-3. The two phase-stators A and B can be seen to be positioned in different planes along the axis and axially separated from each another.

FIGS. 8A and 8B are respective opposite end views of a stator assembly with windings for the step motor of FIGS. 1-3, where FIG. 8A shows the phase-stator A and FIG. 8B shows the phase-stator B for the bipolar step motor. A rotor is also seen fitted inside the central interior diameter of the stator assembly.

FIGS. 9A and 9B are end views of alternative stator assemblies with windings for a bipolar step motor in accord with the present invention, showing a phase-stator for a 2-phase motor in FIG. 9A and another phase-stator for a 3-phase motor in FIG. 9B.

FIGS. 10A-10D show four steps of the two-phase bipolar step motor constructed from the phase-A and phase-B stators and one-pair PM rotor and energized in a sequence A+, B+, A−, B−, . . . to move the rotor in 90° increments.

FIG. 11A is a top plan view and FIG. 11B is a sectional side view taken along a line A-A in FIG. 11A showing an embodiment of a spacer position pin for a step motor in accord with the present invention to maintain a 90° relative shift between the two phase-stators A and B of the stator assembly.

FIGS. 12 and 13 are perspective views of multi-piece rotors for respective 2-phase and 3-phase step motor embodiments in accord with the present invention, where the rotor pieces are mutually offset by 90° in FIGS. 12 and 60° in FIG. 13.

### DETAILED DESCRIPTION

A primary goal is to make a miniature motor that is both easy to manufacture and has relatively higher torque than a conventional stepper design. To achieve this objective, the motor's stator has been separated into identical phase-stators, e.g. a pair of phase-stators A and B for a 2-phase stepper, each of which in turn are assembled from two identical individual sub-stators with windings. Rather than using a winding needle to wind around stator poles after the stator has been assembled, we provide coils that can be wound easily around the respective individual sub-stators prior to assembly. Since each coil generates its own independent magnetic flux path, no losses are created when the sub-stators are assembled. For example, the invention can apply to 2-phase bipolar motors having 4 uniform stator poles. The pair of phase-stators A and B are oriented relative to each other with a 90° axial rotational shift. (In an alternative embodiment, if corresponding stacked sections of a two-piece rotor are provided with a 90° axial rotational shift relative to one another, the pair of phase-stators A and B would be axially aligned.) 3-phase (and 5-phase) step motors, made up of 3 (or 5) phase-stators, are also possible.

The basic design principle is illustrated with reference to several drawing figures. Although motor sizes can vary, 6 mm and 8 mm stepper sizes (motor outer diameters) are representative of the miniaturization made possible with this invention. 2.9 mm and 3.9 mm rotor diameters (with a 0.1 mm gap to the stator inner diameter) are likewise representative of such miniature steppers.

With reference to FIGS. 1-3, an embodiment of a 2-phase step motor 11 in accord with this invention comprises a rotor 13 mounted for rotation on an axial shaft 12 with bearings 14 within the interior diameter of a stator assembly 15. The stator assembly 15 is made up of two phase-stators 16A and 16B kept in proper relative rotational position by a set of axially lengthwise pins 17, e.g. four in number, situated in corresponding axial grooves around the outer diameter of the stator assembly 15. The two phase-stators with windings can be assembled by a plastic injection process with endcaps 18.

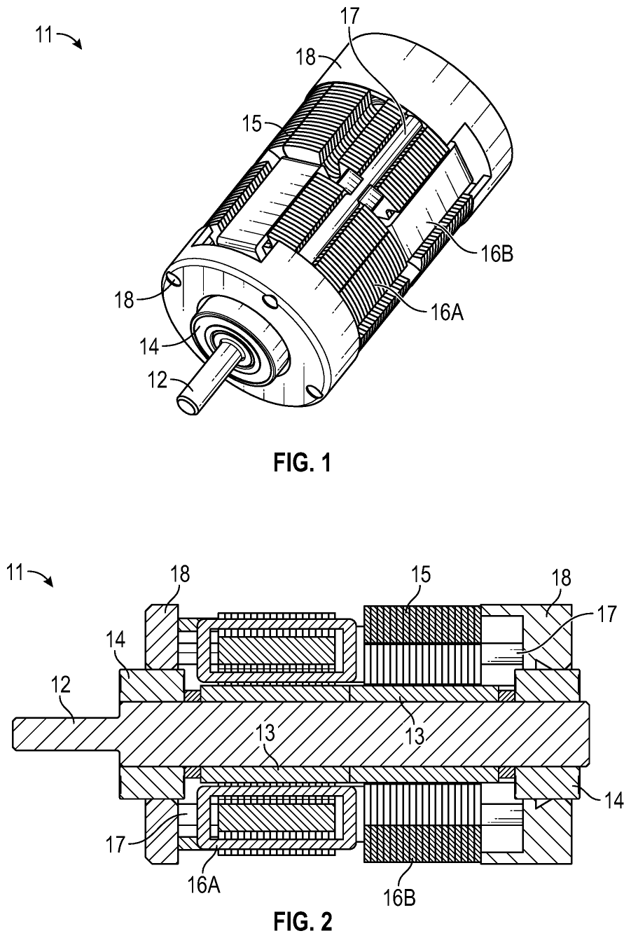

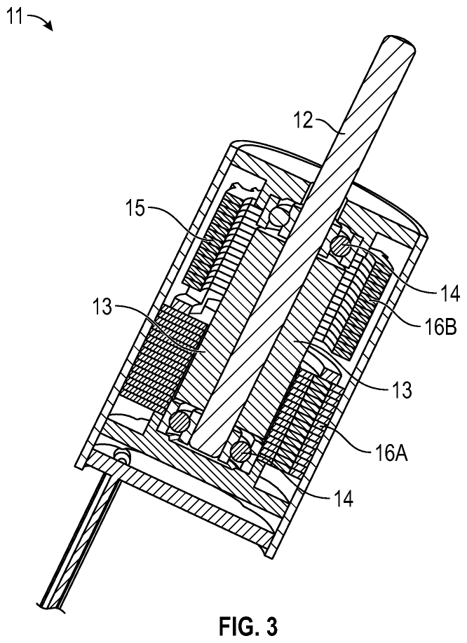

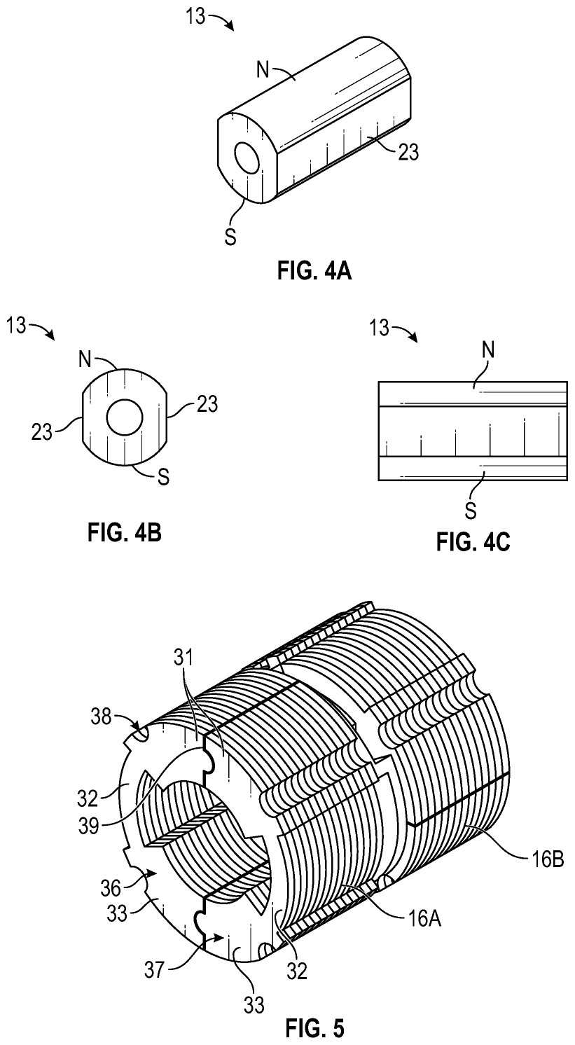

With reference to FIGS. 4A-4C, an embodiment of a rotor 13 for the step motor of FIGS. 1-3 is constructed so as to fit within the stator assembly with a small air gap, typically about 0.1 mm, between the outer diameter of the rotor and the inner diameter of the stator assembly. The PM rotor is a bipolar rotor that has a single pole pair (i.e. one magnetic North pole and one magnetic South pole). Specifically, the rotor 13 can be a strong rare earth magnet with N and S magnetic poles on opposed circumferential portions of the rotor. Two parallel planar sections 23 of the rotor surface may be provided to increase the air gap along the side regions farthest from the N and S poles. The rotor may have a hollow cylindrical inner core, e.g. of about 1.00 mm, to fit onto the motor's axial shaft. The overall diameter of the rotor may be 2.90 mm when the stator's inner diameter is 3.00 mm to create the 0.10 mm air gap. The planar sections 23 may be separated by about 2.51 mm for an increased air gap away from the N and S poles up to about 0.49 mm. The rotor's overall axial length may be about 5.60 mm. All these dimensions are representative of typical stepper motors in accord with this invention but can vary.

With reference to FIGS. 5-7, the stator assembly for a step motor of the present invention has a soft ferromagnetic core forming yokes for the two axially separated phase-stators 16A and 16B. These yokes are normally a laminate of identical thin iron plates stacked together, as seen here. Each phase-stator 16A and 16B is itself composed of two identical sub-stators 36 and 37 that mate with each other like a jigsaw puzzle in mortis-tenon-type joints 39. Each sub-stator 36 and 37 has two polar opposite ends 31 and 33 connected by a thin band 32 around which the conductive wires will be wound form the respective electromagnetic coils. When such coils are energized, one of the two ends 31 and 33 will form a magnetic N pole and the other will form a magnetic S pole: The two sub-stators in any given phase-stator will be energized so that identical magnetic poles are adjacent to form a common pole. Accordingly, the alignment pins also serve, when mounted through motor end plates, to hold the sub-stators together against mutual repulsion, using edge notches 38 or similar registration features. Typically, the respective phase-stators 16A and 16B are physically separated by a spacer 34. The two phase-stators 16A and 16B are also oriented so that they are rotationally shifted about the central axis by 90°.

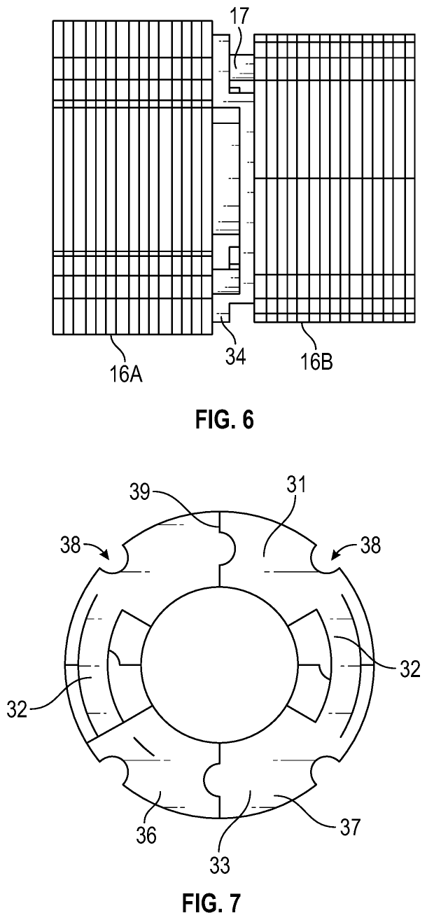

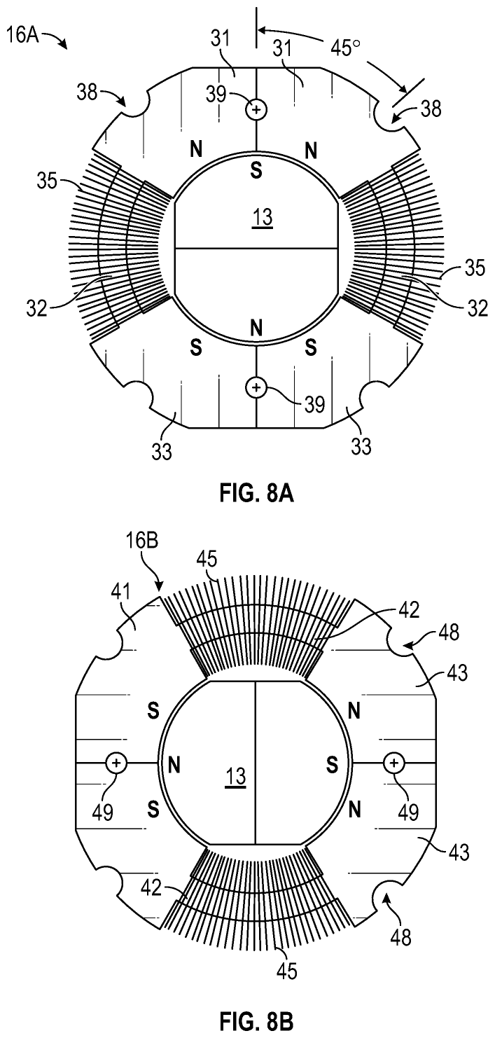

As seen in FIGS. 8A and 8B, the exact form that each sub-stator that makes up the respective phase-stators 16A and 16B can vary somewhat. However, they are generally identical when turned 180°. Common to all is an overall hemicylindrical form with a thin arcuate central band 32 or 42 around which conductive wires 35 or 45 can be wound, forming opposed magnetic poles at end regions 31 and 33 (or 41 and 43 for phase-stator 16B in FIG. 8B). Another common feature is some form of joint structure 39 at the end regions 31, 33, 41, and 43 for the two sub-stators of a phase-stator to be precisely mated to one another. This can take the form, for example, of a mortis-and-tenon type joint. One further common feature is a set of registration features to correctly align the two phase-stators with one another in their expected 90° rotational offset. Here the registration features are a set of notches, e.g. four in number, around the outer diameter of the stator assembly, generally formed in the edges of the end regions 31, 33, 41, and 43. But other type registration features, such as bore holes through the end regions, might also be employed. Corresponding alignment pins 17 are then inserted into those registration features, whether notches or bores, as seen in FIGS. 1, 2 and 6.

Representative dimensions for a the stator assembly elements may include a 3.00 mm inner diameter and a 5.90 mm outer diameter, a phase-stator axial length of about 3.00 mm, a 0.80 mm phase-stator separation, and a total stator assembly axial length of about 6.80 mm. The thin central arcuate band around which the windings are formed may be about 60° to 90° radially long and 1.15 mm wide (e.g. inner edge about 4.25 mm from the central axis and outer edge about 5.40 mm from the central axis) giving about 0.50 mm depth on the outer side for receiving the windings. Alignment notches (or holes) may be hemicylindrical of about 0.28 mm diameter to accommodate nearly identical diameter alignment pins. The notches can be located around 45° and 135° relative to an axial line along the sub-stator joints, giving a wide space therebetween for maximizing the length of the arcuate band for the conductive windings. Again, all these representative dimensions can vary.

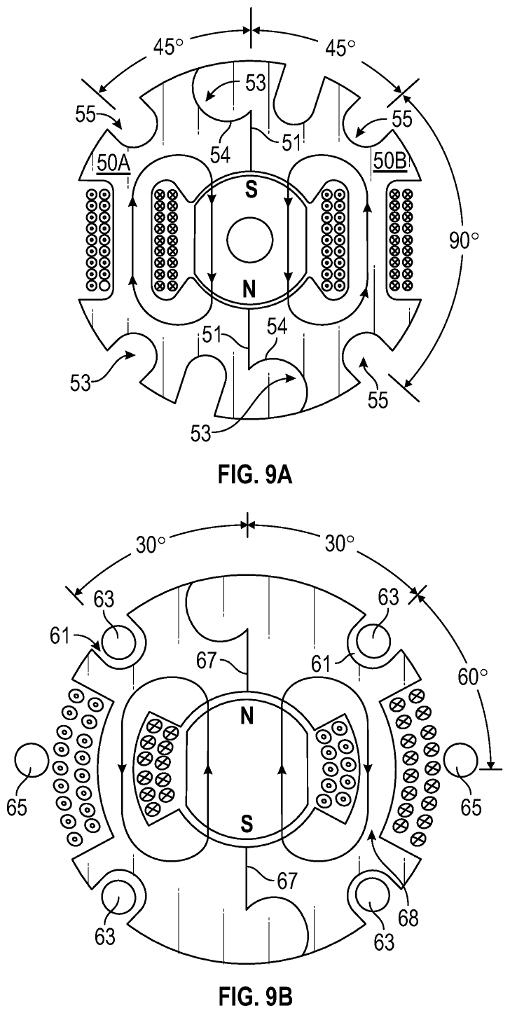

FIG. 9A illustrates an alternative form of phase-stator from that of FIGS. 8A and 8B. The sub-stator joints 51 in FIG. 9A are located further outward, and the mating projections 53 and indentations 54 are larger and curl back slightly against each other, forming an upper notch and lower half-circle that interlock the two sub-stators 50A and 50B. Additionally, the corner alignment notches 55 to correctly position two of such phase-stators are of greater depth. Both features aid the correspondingly larger diameter alignment pins in holding the pair of sub-stators 50A and 50B in abutment to each other against mutual magnetic repulsion when both are energized. The alignment notches 55 are located at angular positions 45° and 135° relative to the line along the joint 51 to ensure 90° relative separation and facilitate a 90° offset between phase-stators in a 2-phase motor. Note that the exact location of the alignment notches will not be critical if the phase-stators are instead aligned with no offset but corresponding rotor sections are offset, as described in further embodiments below. The extra notch 56 in each sub-stator provide a wire exit passage between the phase-stators for the individual phase-stator windings. While not necessary and therefore optional for the topmost stator, it could still be provided on all phase-stators anyway so that manufacture of two distinct types of stator laminations are avoided.

FIG. 9B shows a corresponding phase-stator for a 3-phase motor. The difference from that of FIG. 9A is in the location of the several alignment notches 61 for the respective alignment pins 63 and 65. For a 3-phase motor, if the phase-stators are to be offset (instead of stacked rotor sections), the offset angle needs to be 60°. So, the notches 61 are positioned at 30° and 150° relative to the line through the sub-stator joint. A “third” notch at 90° is excluded to ensure a wide enough central narrow band for the windings 69. Accordingly, the alignment pins 65 pass just outside of the windings 69 but pass, through notches in the other two phase-stators. Likewise, the pins 63 that pass through the notches 61 in the presently shown phase-stator will pass just outside the windings of one of the two other offset phase-stators. This specific phase-stator embodiment is only needed when a one-piece rotor is used and offsetting of the three stacked phase-stators is required.

A 5-phase motor could also be created. However, if the five phase-stators were to be offset by the required 36°, then notches for alignment pins would need to be located at 18°, 54°, 126° and 162° relative to the sub-stator joint line. Again, a notch would be absent at the 90° position, but even so the central band for the windings would be about 18° shorter than the two-phase version. Hence, preferably for the 5-phase motors, a phase-stator embodiment like FIG. 9A for the 2-phase motor would be used, with zero-offset phase-stator alignment and with a 5-piece rotor having the requisite 36° offsets between pieces.

The description here is for a single stack of each phase, but in principle the layered design could be extended, if desired, to multiple shorter phase stators of each phase, such as ABAB or ABBA, with two phase-A and two phase-B stators in such an assembly.

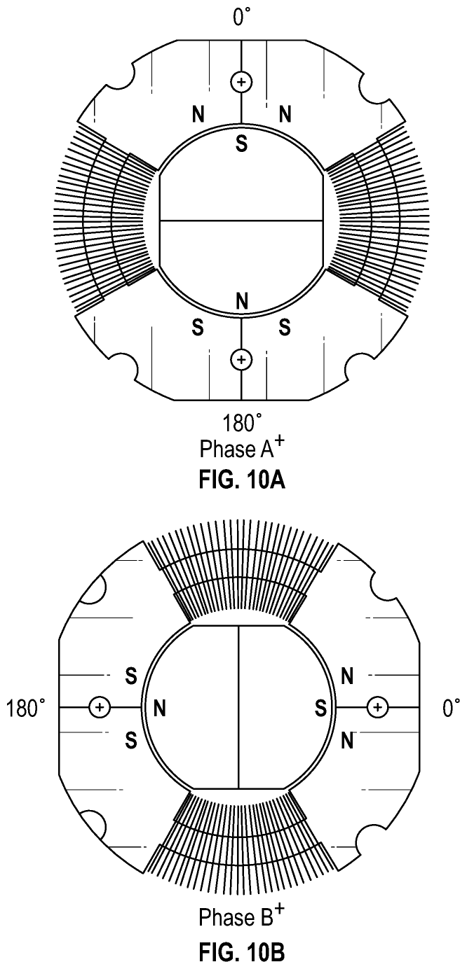

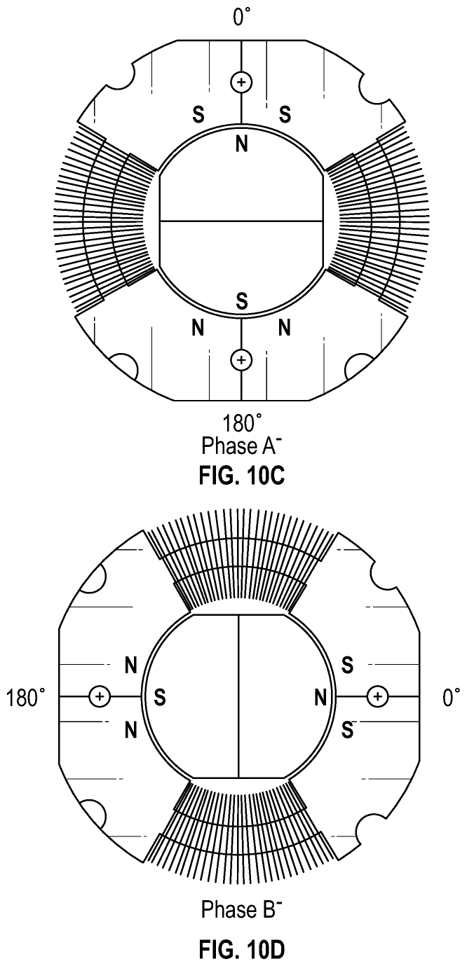

With reference to FIGS. 10A-10D, successive phase-stator energizing steps (A+, B+, A−, B−, drive the turning of the rotor in 90° steps. Phase B is a 90° rotational shift from phase A. The identical sub-stator pieces all have thin central strips around which the conductive wires are wound to form electromagnetic coils or “windings”. These windings, when activated, form a complete magnetic flux path through the air gap to the axially central, permanent magnet (PM) rotor. The flux paths of each sub-stator are independent from one another. (Likewise, the flux paths of each phase-stator are in independent axial planes and do not interfere with each other.) This makes a strong holding position. The two sub-stators in each phase-stator produce a bipolar magnetic flux that for the stator switch in 90° rotating orientations. With a bipolar PM rotor with one N pole and one S pole, the rotor also turns in 90° steps, once for each successive drive phase. These can be seen in FIGS. 10A-10D moving clockwise from one detent position to the next with each successive energized step. Although only the full drive steps are depicted, micro-stepping operation is also possible.

A feature of this invention is using sub-stators with windings to complete a motor assembly. A simple locking design is used for the respective sub-stator pieces in each phase stator of the assembly. One benefit is that each sub-stator piece provides more winding space for a miniature stepper. Another benefit is that every coil generates its own independent flux path with no interference to each other. There is no change of the magnetic flux before and after the sub-stators being assembled. The adjacent surfaces of two sub-stack on the same phase is the natural gap of the two magnetic fluxes. There is no loss of the magnetic flux between the adjacent surface even if there is a big gap in between.

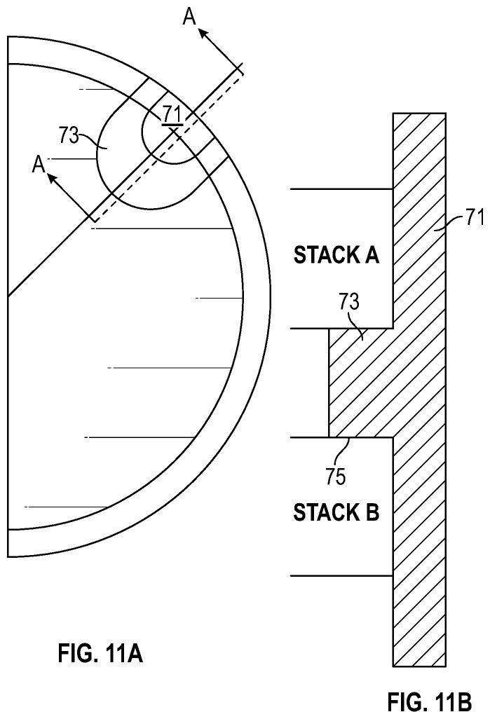

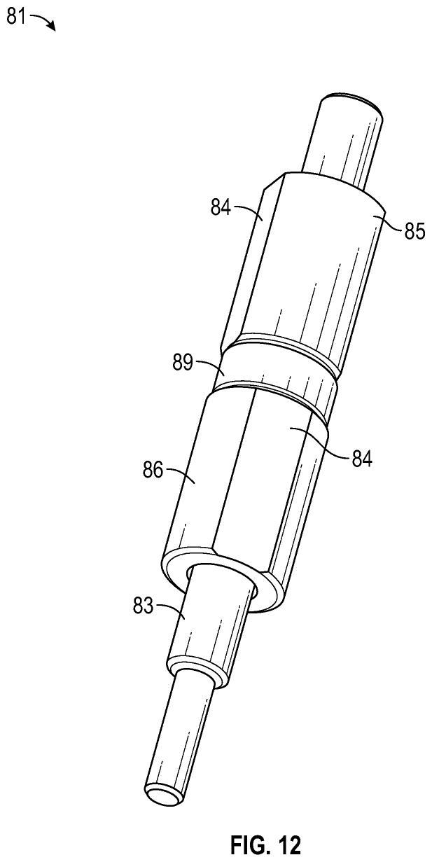

FIGS. 11A and 11B show one possible embodiment for ensuring spacing between the stacked phase-stators in the stator assembly. The stator winding height is about 0.6 mm. Thus, if phase-stators are mutually aligned, we will need at least a 1.2 mm spacing between adjacent phase-stators to accommodate both sets of windings without interference. If the phase-stators mutually offset, the windings will likewise be in different offset locations, so we can reduce the spacing between adjacent phase-stators to about 0.8 mm. In the embodiment shown in FIGS. 11A and 11B, each positioning pin 71 can have one or more spacer extensions 73 that fit between respective pairs of the phase-stators in the stack. The spacer extensions 73 would have an axial width corresponding to the required spacing between the phase-stators and a radial inward extent (e.g. 0.9 mm) that at least reaches between the respective upper and lower phase-stator surfaces 75 to hold the phase-stators apart. Other spacer embodiments, including spacer pads separate from the alignment pins, could be employed provided they do not themselves physically interfere with the windings.

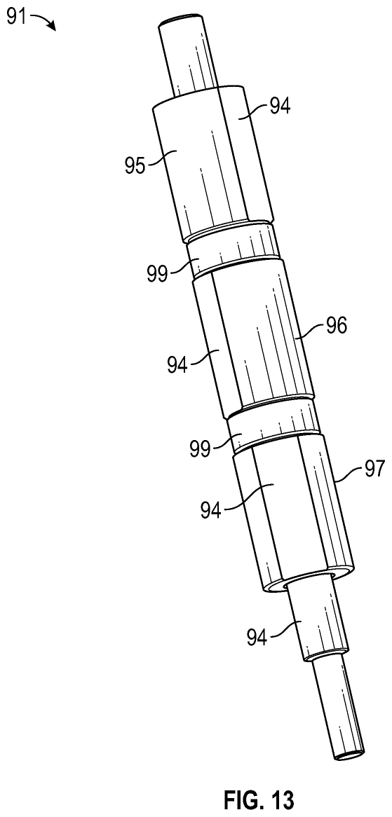

With reference to FIG. 12, a multi-piece rotor 81 is seen to be mounted for rotation on an axial shaft 83. For a two-phase step motor, two rotor pieces 85 and 86 are provided which are mutually offset by 90°. The rotor pieces 85 and 86 are magnetically polarized N-S between opposed cylindrical surfaces. Flat sections 84 may be provided to increase the radial gap between rotor and stator at locations furthest away from those magnetic poles. Spacers 89 separate the rotor pieces 85 and 86 to axially align with the corresponding phase-stators. If such a rotor with mutually offset pieces is employed, the phase-stators of the step motor would themselves all be aligned with zero offset relative to one another.

With reference to FIG. 13, a multi-piece rotor 91 for a three-phase motor is seen. The three rotor pieces 95, 96 and 97 and their spacers 99 are mounted for rotation on an axial shaft 93. The rotor pieces 95, 96 and 97 are magnetically polarized N-S between opposed cylindrical surfaces and have a mutual offset of 60° relative to one another. If desired, flat sections 94 may be provided on each rotor piece to increase the radial gap between rotor and stator at locations furthest way from the magnetic poles. When employed, this three-piece rotor is used together with a stator assembly whose three stacked phase-stators are all mutually aligned with zero offset. In that case, the alternative phase-stator embodiment of FIG. 9B need not be used.

The concept can be extended to a five-phase rotor, wherein five rotor pieces are mutually offset in their magnetic pole orientations by 36°. The stator assembly would comprise five stacked phase-stators like that seen in FIG. 9A, where all five phase-stators are mutually aligned with zero offset, the relative 36° rotor-stator offsets being provided instead by the rotor.

What is claimed is:

1. A step motor, comprising:
a permanent magnet rotor mounted for rotation on an axial shaft, the rotor having at least one axial section, each section having a pair of magnetic poles on opposed circumferential surfaces;
a hybrid stator assembly with an inner diameter to receive the rotor therein, and formed from a stack of phase-stators positioned in different axial planes, each phase-stator interacting with the at least one rotor section via a two-dimensional magnetic flux path that is independent of every other phase-stator in the stack;
wherein the at least one rotor section and the phase-stators have different amounts of rotor-stator rotational offsets at specified angles 180°/N relative to each other about the axial shaft, where N is the number of motor phases.

2. The step motor as in claim 1, wherein there is a single axial section of the rotor and the different phase-stators are rotationally offset by the specified angles 180°/N relative to each other about the axial shaft.

3. The step motor as in claim 2, wherein the hybrid stator assembly comprises two stacked phase-stators A and B that are oriented 90° relative to each other about the axial shaft to form a two-phase motor.

4. The step motor as in claim 2, wherein the hybrid stator assembly comprises three stacked phase-stators A, B and C that are oriented 60° relative to each other about the axial shaft to form a three-phase motor.

5. The step motor as in claim 1, wherein the different phase-stators are all rotationally aligned and the rotor has N axial sections that are rotationally offset by the specified angles 180°/N relative to each other about the axial shaft.

6. The step motor as in claim 5, wherein there are two rotor sections that are oriented 90° relative to each other about the axial shaft, each rotor section interacting with a different one of two corresponding phase-stators A and B to form a two-phase motor.

7. The step motor as in claim 5, wherein there are three rotor sections that are mutually oriented 60° relative to each other about the axial shaft, each of the three rotor sections interacting with a different one of three corresponding phase-stators A, B and C to form a three-phase motor.

8. The step motor as in claim 1, wherein each phase-stator comprises a pair of C-shaped sub-stators, each sub-stator with a thin middle strip wound with coils and two outer end portions forming stator poles, the pairs of sub-stators assembled to form the respective phase-stators.

9. A step motor, comprising:
a permanent magnet rotor mounted for rotation on an axial shaft, the rotor having at least one pair of magnetic poles formed by strips of rare-earth magnet material arranged axially on the rotor with alternating north and south magnetic polarity around a circumference of the rotor; and
a hybrid stator assembly with an inner diameter to receive the rotor therein, and formed from a stack of phase-stators positioned in different axial planes, the different phase-stators in the stack oriented at a specified angle 180°/N relative to each other about the axial shaft, where N is the number of motor phases, each phase-stator interacting with the rotor via a two-dimensional magnetic flux path that is independent of the other phase-stators in the stack.

10. The step motor as in claim 9, wherein the rotor is a bipolar rotor with one north magnetic pole and one south magnetic pole.

11. The step motor as in claim 9, wherein the rotor has a diameter of at most 4 millimeters.

12. The step motor as in claim 9, wherein each phase-stator comprises a pair of C-shaped sub-stators, each sub-stator with a thin middle strip wound with coils and two outer end portions forming stator poles, the pairs of sub-stators assembled to form the respective phase-stators.

13. The step motor as in claim 9, wherein the hybrid stator assembly comprises two stacked phase-stators A and B that are oriented 90° relative to each other about the axial shaft to form a two-phase motor.

14. A two-phase step motor, comprising:
a bipolar permanent magnet rotor of rare-earth material mounted for rotation on an axial shaft, the rotor with one magnetic north polar and one magnetic south pole on opposite sides around a circumference of the rotor; and
a hybrid stator assembly with an inner diameter to receive the rotor therein, and formed from a stack of phase-stators A and B positioned in different axial planes, the different phase-stators A and B in the stack oriented 90° relative to each other about the axial shaft, each phase-stator interacting with the rotor via a two-dimensional magnetic flux path that is independent of the other phase-stators in the stack, wherein successive energization steps of phases A+, B+, A−, and B− drive rotor full steps of 90°.

15. The step motor as in claim 14, wherein each phase-stator comprises a pair of C-shaped sub-stators, each sub-stator with a thin middle strip wound with coils and two outer end portions forming stator poles, the pairs of sub-stators assembled to form the respective phase-stators.

16. A method of forming a step motor, comprising:
stacking a set of sheet laminations of soft ferromagnetic material to form at least four identical sub-stators, each sub-stator having a thin middle strip and two outer end portions;
winding the thin middle strip of each sub-stator with conductive wires to form electromagnetic coils that when energized form stator poles in the two outer end portions;
assembling pairs of sub-stators to form at least two phase-stators, the sub-stators mating with each other at their two outer end portions in interlocking joints;
stacking the phase-stators to form a stator assembly, different phase-stators A and B in the stack kept oriented 90° relative to each other about a central axis by registration features including a set of alignment pins, each phase-stator interacting with the rotor via a two-dimensional magnetic flux path that is independent of the other phase-stators in the stack; and
mounting a permanent magnet rotor for rotation on an axial shaft within the stator assembly, the rotor having at least one pair of magnetic poles formed by rare-earth magnet material arranged axially on the rotor with alternating north and south magnetic polarity around a circumference of the rotor, wherein successive energization steps of phases A+, B+, A−, and B− of the stator assembly drive stepping of the rotor between successive detent positions.
